(19) United States
(12) Patent Application Publication
(10) Pub. No.: US 2003/0183809 A1
(43) Pub. Date: Oct. 2, 2003

(54) Heat resistant organoclay

(76) Inventors: Masanobu Onikata, Gunma (JP); Mituru Ohya, Annaka-si (JP); Mitsuji Kondo, Annaka-si (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/279,028

(22) Filed: Oct. 24, 2002

(30) Foreign Application Priority Data
Mar. 29, 2002 (JP) 2002-097243
Sep. 13, 2002 (JP) 2002-268050

(51) Int. Cl. C09K 15/00; C04B 14/04

(52) U.S. Cl. 252/397; 106/487

(57) ABSTRACT

A heat resisting organoclay which, when incorporated to plastic compounds at high processing temperature in excess of 150° C., does not discolor the plastics, as well as a method of manufacture thereof, is provided. Antioxidant is intercalated between interlayers of the clay flakes to make a heat resistant organoclay. More specifically, antioxidant dissolved in a water-soluble organic solvent is added to a raw filter cake of organoclay for mixing. Alternatively, an aqueous solution of organic cations and antioxidants is added to a clay-water suspension. Then, they are mixed, filtered, dried and pulverized to produce a heat resistant organoclay.

### BACKGROUND OF THE INVENTION

1. Field of the Invention

The present invention relates to an improved heat-resistant organoclay that does not discolor plastics even when the organoclay is incorporated to a plastic compound at an elevated processing temperature higher than approximately 150 degrees Celsius, and also to a method of manufacturing such an organoclay.

2. Description of the Prior Art

As already known, an organoclay modifies physical properties such as viscosity, thixotropy, mechanical properties, barrier properties and so on, as its flakes are delaminated and dispersed in body of organic materials.

Because of the performance of the organoclay, it has found applications in a wide range of field, including inks, greases, cosmetics, sealant and organic coatings as an agent for thickening and/or rheology controlling. In recent years, it has also been spotlighted as functional filler. It significantly improves mechanical properties of plastics, such as strength, elastic modulus and thermal deformation, as well as other properties such as inflammability, gas permeability and visible clarity when the flakes of the organoclay are delaminated and dispersed in as small a size as a nanometer unit in a variety of polymers.

An ordinary or conventional organoclay is made through a cation exchange reaction between smectite clay such as montmorillonite and organic cations having at least a long chain alkyl group such as quaternary tallow ammonium cation. The organic cation is intercalated into the interlayer of smectite flakes and the smectite is converted to oleophilic so that swells its volume in organic solvents.

The organoclay processed in the conventional method described above has a crystal interlayer distance of about 2-3 nanometers and thus forms a layer crystal structure with an increased Van der Waals force acting crystal layers.

Kneading this organoclay in a molten polymer compound heated to over 150° C. causes long chain alkyl groups of quaternary ammonium cations, that is, the organic radical of the cation intercalated into the interlayer and adsorbed on the smectite layer surfaces of the organoclay, to be thermally decomposed and change their colors, which in turn discolors the plastic product. This limits the use of plastics containing organoclay, and the polymers for which the organoclay can be used are limited to those whose processing temperatures are lower than 150° C. These are among many problems posed by the conventional organoclay.

The present invention has been accomplished under these circumstances and its object is to provide a improved heat-resistant organoclay that does not discolor a plastic compound even when the organoclay is kneaded with a plastic compound at an elevated processing temperature higher than approximately 150° C., and also to provide a method of manufacturing the same.

### SUMMARY OF THE INVENTION

The inventors of this invention have conducted extensive research to solve the above-mentioned problem and found that a novel and improved heat-resistant organoclay can be obtained by coexisting an organoclay with a small amount of an antioxidant, that is, adding a small amount of an antioxidant to the well moist organoclay flakes and kneading or mulling them while the crystal interlayer distance of the organoclay flaks is sufficiently large, or alternatively by adding a mixture of organic cations and an antioxidant dissolved in water-soluble organic solvent to a clay-water suspension and mixing them. Based on this finding, the inventors achieved the present invention.

That is, it is to provide a novel and improved heat-resistant organoclay which, when kneaded with a plastic compound at an elevated temperature in excess of 150° C. during its processing, does not change the color of the plastic product. Therefor, the present invention performs the process of adding an antioxidant dissolved in a water-soluble organic solvent to a raw filter cake of the organoclay from its aqueous suspension that has an increased crystal interlayer distance of 9 nanometers or more, and kneading or mulling them. Then, the cake is dried and pulverized in powder.

Alternatively, a solution of an antioxidant, a quaternary ammonium cation and a water-soluble organic solvent is added to a clay-water suspension while powerfully agitating on a mixer, then the produced organoclay is filtered, dried and pulverized.

### DETAILED DESCRIPTION OF THE INVENTION

According to one example embodiment, the present invention will be described in detail. In implementing this invention, clay is first delaminated and dispersed thoroughly in water. And then organic cations dissolved in water, alcoholic water or alcohol, equal in amount to about 0.5-2.0 times the cation exchange capacity of clay, is added to the clay suspension to replace exchangeable sodium ions lying between interlayer of clay with organic cations. Thus intercalating organic cations into the interlayer of clay flakes produces an organoclay, whereby the interlayer exhibits oleophilic ability having swelling potential in various organic liquids.

Next, this suspension is filtered and washed to remove residual organic cations and inorganic salts, and the resulting moist organoclay filter cake (i.e. raw filter cake) is obtained. The organoclay cake is mixed with a kneader or a muller with 0.01-5.0% by weight, with respect to the organoclay solid content, of antioxidant dissolved in a water soluble organic solvent such as ethanol, and then the mixture is dried and pulverized to provide a improved heat-resistant organoclay.

In this invention, the similar heat resisting organoclay can also be obtained by adding a solution containing the above-described amounts of organic cations and antioxidant dissolved in a water soluble organic solvent to the clay-water suspension, and by operating steps of agitating, filtering, washing, drying and pulverizing sequentially.

Among clays applicable to this invention are smectite clays, such as montmorillonite, beidellite, hectorite, saponite, stevensite, sauconite and nontronite and synthetic smectite type silicates, and mixtures of these.

Further, organic cations that can be used in this invention include quaternary ammonium salt, phosphonium salt, sulformium having at least a long chain alkyl radical and mixtures of these.

Quaternary aminonium salts include benzyltrialkyl ammonium such as dodecylbenzyldimethyl ammonium (benzalkonium), octadecylbenzyldimethyl ammonium and benzyltributyl ammonium, alkyltrymethyl ammonium such as octadecyltrimethyl ammonium, dodecyltrimethyl ammonium, dialkyldimethyl ammonium such as dioctadecyidimetyl ammonium and didodecyidimethyl ammonium, trialkylmethyl ammonium such as trioctylmethyl ammonium and tridodecylmethyl ammonium, and also benzethonium ions.

Antioxidants applicable to this invention include phenol-, sulfur-, phosphorus- and amine-based antioxidants and mixtures of these.

Phenol-based antioxidants include 2,6-di-t-butyl-4-methylpenol, 2,6-di-t-butyl-4-ethylphenol, n-octadecyl-3-(3,5-di-t-butyl-4-hydroxyphenyl)propionate, tetrakis-[methylene-3-(3′,5′-di-t-butyl-4′-hydroxyphenyl)propionate]methane, tris(3,5-di-t-butyl-4-hydroxybenzyl)isocyanurate, triethylen glycol-bis-[3-(3-t-butyl-4-hydroxy-5-methylphenyl)propionate, 2,2′-methylenebis-(4-methyl-6-t-butylphenol), 2,2′-methylenebis-(4-ethyl-6-t-butylphenol), 4,4′-thiobis-(3-methyl-6-t-butylphenol), 4,4′-butylidenbis-(3-methyl-6-t-butylphenol), and 1,1,3-tris-(2-methyl-4-hydroxy-5-t-butylphenyl)butane.

Sulfur-base antioxidants include dilauryl-3,3′-thiodipropionate, dimyristyl-3,3′-thiodipropionate, distearyl-3,3′-thiodipropionate, pentaerythrityltetrakis(3-dodecylthiopropionate), and ditridecylthiodipropionate.

Phosphorus-based antioxidants include trisnonylphenyl phosphite, distearylpentaerythritol-di-phosphite, tris(2,4-di-t-butylphenyl)phosphite, and tetrakis(2,4-di-t-butylphenyl)-4,4-biphenylene-di-phosphite.

Amine-based antioxidants include diphenylamine derivative, polymerized 2,2,4-trimethyl-1,2-dihydroquinoline, N-isopropyl-N′-phenyl-p-phenylenediainine, and N-1,3′-dimethylbutyl-N′-phenyl-p-phenylenediamine.

In this invention, the amounts of these antioxidants to be added are set at 0.01-5.0% by weight, and preferably 0.1-1.0% by weight, of the organoclay.

As described above, the organoclay according to this invention is made by adding, after a filtering step before a drying step, an antioxidant dissolved in an water-soluble organic solvent to a moist filter cake of the organoclay that has an increased crystal interlayer distance (i.e. basal plane spacing of clay mineral lattice) of 9 nanometers or more, and then kneading or mulling them. Then the cake is dried and pulverized in powder. Alternatively above, a solution of antioxidant, a quaternary ammonium cation and a water-soluble organic solvent is added to a clay-water suspension while powerfully agitating on a mixer, then the produced organoclay is filtered from the reacted suspension, washed, dried and pulverized. In both processes, the antioxidant is intercalated into the interlayer of the organoclay flakes.

Both processes provide a novel and improved heat-resistant organoclay which, when kneaded with a plastic compound at an elevated temperature in excess of 150° C. during its processing, does not change the color of the plastic product (or minimizes discoloration of the plastic product). Therefor, it is possible to substantially expand the use of plastic products containing the organoclay according to this invention, since the natively excellent decorativeness of plastics is not damaged with the organoclay.

If using post-treating with an antioxidant to a conventional organoclay, it requires re-delaminating and re-dispersing an organoclay in an organic solvent to intercalate an antioxidant into interlayer of the clay flakes of dry solid state. Whereby its interlayer lattice closed due to an increased Van der Waals force changes in open lattice structure that can be intercalated an antioxidant. However, this process takes a great deal of time, labor and energy for removing and drying volumes of the expensive organic solvent. In contrast to this, it is very obvious that the organoclay with antioxidant intercalated into interlayer of the clay flakes by the method of this invention is advantageous also in terms of cost.

### EXAMPLE 1

This example is two steps process.

1. Preparation of Conventional Organoclay

9.4 litters of 0.1M-dimethyldioctadecyl ammonium chloride solution (15 vol. % isopropanol, 70° C.) were added to 50 litters of 2% (by wt.) montmorillonite (Hojun Co.Ltd., Bengel-A™) suspension (25° C.) with powerfully agitating for 2 hours. Then the suspension was filtered and washed by using a laboratory filter press, and 17.2 kg of the filter cake (I) was yielded. The filter cake consisted of 1,495 g of dimethyldioctadecyl anmmonium-montmorillnite (II) and 15.7 kg of water. X-ray diffraction analysis of the moist organoclay cake found that the basal plane spacing of the clay was 9.0 nanometers.

2. Treating with Antioxidant

2.3 kg of the raw filter cake (I) [200 g of (II)] was charged in a laboratory kneader and 20 ml of 1% ethanol solution of amine-based antioxidant (Kawaguchi Chemical Industry Co.Ltd., Antage DDA™, 0.2 g) was added slowly for about 5 minutes to the content of the kneader on running. Kneading was continued for 30 minutes, then the content of the kneader was transferred a laboratory air oven (80° C.) and followed by drying (moisture content:7% by wt) and pulverizing (200 mesh) sequentially. 207 g of the product (III) for the present invention was yielded

1.0 g or 2.0 g of the same antioxidant was added with operating like described above, and the product (IV) or (V) for the present invention was obtained corresponding with the amount of the antioxidant respectively.

### EXAMPLE 2

The raw filter cake (I) from Example 1 was treated with phenol-based antioxidant (Yoshitomi Fine Chemical Co.Ltd., Tominox™ 917). In this example, the treating operation was similar to that of Example 1, and also a quantity of the antioxidant added to the organoclay (II) was same to that of Example 1, that is 0.1, 0.5 or 1.0% by wt. to (II), except to add phenol-based antioxidant alternatively amine-based antioxidant. Therefore, the product for the present invention corresponding with a quantity added of the antioxidant was yielded as the product (VI), (VII) or (VIII) be equivalent to 0.1, 0.5 or 1.0% respectively.

### EXAMPLE 3

The raw filter cake (I) from Example 1 was treated with another phenol-based antioxidant (Yoshitoini Fine Chemical Co.Ltd., Yoshinox™ BB). In this example, the treating operation was similar to that of Example 1, and also a quantity of the antioxidant added to the organoclay (II) was same to that of Example 1, that is 0.1, 0.5 or 1.0% by wt. to (II), except to add phenol-based antioxidant alternatively amine-based antioxidant. Therefore, the product for the present invention corresponding with a quantity added of the antioxidant was yielded as the product (IX), (X) or (XI) be equivalent to 0.1, 0.5 or 1.0% respectively.

### EXAMPLE 4

The raw filter cake (I) from Example 1 was treated with another sulfur-based antioxidant TM (Yoshitomi Fine Chemical Co.Ltd., Tomiphos™ 202). In this example, the treating operation was similar to that of Example 1, and also a quantity of the antioxidant added to the organoclay (II) was same to that of Example 1, that is 0.1, 0.5 or 1.0% by wt. to (II), except to add phenol-based antioxidant alternatively amine-based antioxidant. Therefore, the product for the present invention corresponding with a quantity added of the antioxidant was yielded as the product (XII), (XIII) or (XIV) be equivalent to 0.1, 0.5 or 1.0% respectively.

(Evaluation on Thermal Aging Property)

An objective of the present invention is to provide an organoclay, which has an improved heat-resistant property when it is incorporated into plastic compounds by kneading at high processing temperature more than about 150° C. Most organic materials such as rubber and plastics are acceleratingly oxidized by temperature in air or oxygen atmosphere and their physical, mechanical, and chemical properties are degraded with significantly discoloring. This phenomenon is well known as “thermal aging” (Plastic Age's Practical Dictionary of Plastics Technical Terms 3^{rd} Ed. pp.485). Therefore, discoloration of a test specimen is an excellent indicator for a degree of thermal resistance of organic materials.

The thermal aging property of the products of the present invention was evaluated by observing the discoloration using an accelerated aging test at 250° C. in an electric air oven. As control examinant, some conventional organoclays were tested simultaneously. 3 g of the organoclay sample was put in a ceramic boat and placed in the oven held at 250±1° C. The sample was maintained for 5 minutes in the oven and sequentially brought out from the oven, followed by cooling for 1 minute at room temperature. This heat-cool cycle was repeated 12 times (i.e. integral time of heating for 60 minutes). Then, the Hunter brightness of the specimens before and after oven treatment was measured by using Murakami's Color and Gloss Meter and the magnitude of discoloration was determined from Equation 1. The results are shown in Table 1.

$$\% discoloraton = \frac{( before brightness ) - ( after brifhtness )}{( before brightness )} \times 100 \qquad ( 1 )$$

TABLE 1
Results of accelerated aging test

| | | Amount | Hunter | | % |
|---|---|---|---|---|---|
| | | added of | Brightness | | Dis- |
| Sample of | Name of | antioxidant | Before | After | color- |
| organoclay | antioxidant | (%) | (%) | (%) | ation |
| Product of the | | | | | |
| present invention | | | | | |
| III | Antage ™ | 0.1 | 58.2 | 51.3 | 11.9 |
| IV | DDA | 0.5 | 58.2 | 48.3 | 17.0 |
| V | | 1.0 | 58.2 | 43.3 | 25.6 |
| VII | Tominox ™ | 0.1 | 59.2 | 49.2 | 16.9 |
| VII | 917 | 0.5 | 55.0 | 47.0 | 14.5 |
| VIII | | 1.0 | 50.6 | 47.0 | 7.1 |
| IX | Yoshinox ™ | 0.1 | 60.1 | 47.0 | 21.8 |
| X | | 0.5 | 59.2 | 47.5 | 19.8 |
| XI | | 1.0 | 63.8 | 44.7 | 29.9 |
| XII | Tomiphos ™ | 0.1 | 59.0 | 25.1 | 57.5 |
| XIII | 202 | 0.5 | 57.5 | 41.0 | 28.7 |
| IVX | | 1.0 | 59.7 | 46.7 | 21.8 |
| Conventional | | | | | |
| organoclay | | | | | |
| II¹⁾ | — | — | 59.3 | 17.1 | 71.2 |
| Cloisite ™ 6A²⁾ | — | — | 77.1 | 23.1 | 70.0 |
| Cloisite ™ 15A³⁾ | — | — | 74.5 | 27.0 | 63.8 |
| Claytone ™ HY⁴⁾ | — | — | 72.3 | 37.9 | 47.6 |
| Bentone ™ 34⁵⁾ | — | — | 52.2 | 24.4 | 53.3 |
| Tixogel ™ VP⁶⁾ | — | — | 62.3 | 35.5 | 43.0 |
| New D Orben ™⁷⁾ | — | — | 68.8 | 29.7 | 56.8 |

¹⁾Dimethyldioctadecyl ammonium montmorillonite. This sample was produced by drying and pulverizing the filter cake from Example 1.
²⁾Commercially available organoclay, a product of Southern Clay Products, Inc.
³⁾As above.
⁴⁾As above.
⁵⁾Commercially available organoclay, dimethyldioctadecyl ammonium montmorillonite, a product of Rheox, Inc.
⁶⁾Commercially available organoclay, a product of Süd Chemie.
⁷⁾Commercially available organoclay, a product of Shiraishi Kogyo K.K.

As shown in table 1, the products of the present invention showed excellent anti-discoloration to the accelerated aging test condition, whereas all of the conventional organoclay, which do not intercalate antioxidant, showed conspicuous discoloration with the same accelerated aging test condition. An exception was only Product XII that percent discoloration was over 50 due to insufficiency of quantity of the antioxidant.

### EXAMPLE 5

This example is one-step process.

Preparation of Reactants:

1) 2% Montmorillonite Suspension

2,000 g of montmorillonite (Hojun Co.Ltd., Bengel™ A, moisture content: 8.0%, CEC: 94 meq/100 g) was added to 100 litters of deionized water while stirring on Disper [Asada Tekko Co. Ltd., a high-speed (1480 rpm) corrugated impeller mixer-disperser]. After continued the stirring for 30 minutes, the suspension was stood for overnight at room temperature for aging.

2) Antioxidant-Quaternary Ammonium Chloride Solution

1,280 g of dimethyidioctadecyl ammonium chloride (purity:95%) was solved into 11.5 litters of alcoholic water (10 litters of deionized water and 0.15 litters of isopropanol) at 70° C., then sequentially 15, 30, 60, 90 or 120 g of 10% antioxidant isopropanol solution (Kawaguchi Chemical Co.Ltd., Antage™ DDA, amine-based) was added to the quaternary ammonium salt solution and solved at 70° C. while stirring on a mixer for a few minutes. The solution was obtained as a translucent colloid liquid.

Preparation of Organoclay Intercalated Antioxidant

The antioxidant-quaternary ammonium salt solution was added to the clay suspension while stirring on Disper. After 30 minutes, the suspension was filtered and washed by using a laboratory filter press. Then the filter cake of the organoclay was processed sequentially by drying (moisture content: 7.2%) in a laboratory dryer at 60° C., and by pulverizing with a hammer mill to 150 mesh. About 3.1 kg of the organoclay intercalated the antioxidant was yielded. The antioxidant content of each product is 0.5, 1.0, 2.0, 3.0 or 4.0%. A control organoclay be intercalated no any antioxidant was also prepared by reacting the same materials and like operating them.

Evaluation on Thermal Aging Property

The thermal aging property of the products of Example 5 was evaluated by observing the discoloration (Equation 1) using an accelerated aging test on heating for 30 minutes at various temperatures. The test apparatus used were the same as mentioned above. Results are shown in Table 2.

TABLE 2
Results of accelerated aging test

| Temp. | Hunter Brightness (%)/(Percent Discoloration) | | | | | |
|---|---|---|---|---|---|---|
| (° C.) | Control | 0.5% | 1.0% | 2.0% | 3.0% | 4.0% |
| Blank | 53.6/(0) | 56.9/(0) | 53.6/(0) | 53.4/(0) | 51.3/(0) | 49.8/(0) |
| 200 | 46.9/(6.9) | — | 50.3/(6.2) | — | — | — |
| 225 | 17.5/(67.4) | 30.5/(46.4) | 42.0/(21.6) | 42.1/(21.2) | 36.5/(28.8) | 33.2/(33.3) |
| 230 | 13.0/(75.7) | — | 33.7/(37.1) | 38.4/(28.1) | — | — |
| 235 | 11.6/(78.4) | — | 27.3/(49.1) | 25.7/(51.9) | — | — |
| 240 | 11.1/(79.3) | — | 20.1/(62.5) | — | — | — |
| 250 | 8.0/(85.1) | — | 9.8/(81.7) | — | — | — |

As shown in Table 2, a magnitude of percent discoloration of the control sample without any antioxidant is over 67% at 225° C., whereas all of the products of the present invention show substantially a good anti-discoloration property. And also, it is obvious that the optimum quantity of the antioxidant added to the organoclay is 1.0% to 2.0%.

What is claimed is:

1. A heat resistant organoclay having an antioxidant intercalated between interlayer of the clay.

2. A heat resistant organoclay according to claim 1, wherein the antioxidant is a mixture of one or more of phenol-, sulfur-, phosphorus- and amine-based antioxidants.

3. A heat resistant organoclay according to claim 1 or 2, wherein an amount of the antioxidant to be added is 0.01-5.0% by weight with respect to the organoclay.

4. A method of manufacturing a heat resistant organoclay comprising the steps of:
adding an antioxidant dissolved in a water soluble organic solvent to a raw filter cake of organoclay; mixing the antioxidant and the clay; drying and pulverizing the clay.

5. A method of manufacturing a heat resistant organoclay comprising the steps of:
adding a mixed aqueous solution of an organic cation and an antioxidant to a clay-water suspension; mixing, filtering, drying and pulverizing the clay.

6. A method of manufacturing a heat resistant organoclay according to claim 4 or 5, wherein the antioxidant is a mixture of one or more of phenol-, sulfur-, phosphorus- and amine-based antioxidants.

7. A method of making a heat resistant organoclay according to any one of claim 4 to 6, wherein an amount of the antioxidant to be added is 0.01-5.0% by weight with respect to the organoclay.
